(19) United States
(12) Patent Application Publication
(10) Pub. No.: US 2005/0249195 A1
(43) Pub. Date: Nov. 10, 2005

(54) Methods, systems and computer program products for handling multiple incoming calls simultaneously using central office voice over network (co_von)

(76) Inventor: Anita Simpson, Decatur, GA (US)

Correspondence Address: MYERS BIGEL SIBLEY & SAJOVEC, P.A., P.O. BOX 37428, RALEIGH, NC, 27627, US

(21) Appl. No.: 11/089,296

(22) Filed: Mar. 24, 2005

Related U.S. Application Data
(60) Provisional application No. 60/623,669, filed on Oct. 29, 2004.
(60) Provisional application No. 60/569,504, filed on May 7, 2004.
(60) Provisional application No. 60/615,922, filed on Oct. 5, 2004.

(51) Int. Cl. H04L 12/66

(52) U.S. Cl. 370/352

(57) ABSTRACT

Methods for handling multiple incoming calls using voice over network services are provided. Instructions are received at a trunk gateway to apply a selected call waiting feature responsive to a new call request on a voice over network line involved in an active call. The selected call waiting feature is applied at the trunk gateway to the voice over network line involved in the active call responsive to the received instructions. Related systems and computer program products are also provided.

### RELATED APPLICATIONS

This application claims priority to Provisional Application No. 60/623,669 (Attorney Docket No. 9400-153PR), filed on Oct. 29, 2004, the contents of which is incorporated herein by reference as if set forth in its entirety. This application is related to U.S. Provisional Application No. 60/569,504 filed May 7, 2004 and U.S. Provisional Application No. 60/615,922, filed Oct. 5, 2004, the contents of which are hereby incorporated herein by reference as if set forth in its entirety.

### FIELD OF THE INVENTION

This invention relates to methods, systems and computer program products related to voice over network (VON) and, more particularly, to methods, systems and computer program products for handling incoming calls on VON.

### BACKGROUND OF THE INVENTION

Internet telephony, also referred to herein as Voice-Over Internet Protocol (VoIP), Voice-Over Network (VON), and/or Internet Protocol Telephony (IP Telephony), is becoming increasing popular due, in part, to marked improvements in reliability and sound quality of the service. The improved performance of Internet telephony communications may be due, in large part, to upgrading the internet backbone with improved switching fabrics, such as Asynchronous Transfer Mode (ATM) and to implementation of new communications standards, such as standards for transport protocols, directory services, and/or audio codec format.

Currently, to provide Internet telephony communications to a subscriber, a subscriber must obtain equipment, such as Integrated Access Devices (IADs), Analog Terminal Adaptors (ATAs), telephone adapters (TAs) and the like, to be installed at the subscriber's premises, for example, a customer's home. The equipment is needed to support a voice path within the premises and through the broadband connection, for example, a digital subscriber link (DSL) connection, back to the Internet Service Provider (ISP). Once the necessary equipment is installed, customers/subscribers can connect their existing analog phones, for example, Plain Old Telephone Service (POTS) phones, to the Analog Terminal Adaptors (ATAs) or telephone adapters (TAs) to originate and/or receive calls using Internet telephony, for example, over a VON line. A VON dial-tone is provided by the telephone adaptor (TA) to any phone extensions with ATAs connected.

Although, the idea of Internet Telephony may be attractive to customers, some customers may not be willing to purchase and/or install the required equipment necessary to enable use of Internet telephony services, for example, VON services. Furthermore, although customers are used to Internet power outages that may cause them to be unable to access their email on the world wide web (www), customers may not be willing to accept these types of Internet or power outages and unpredictability of these outages when it comes to VON service, i.e., their telephone service.

Similarly, Internet Service Providers (ISPs), i.e., providers of data communications network services, typically like to avoid professional installation of equipment to minimize their payback period and increasing their Return-On-Investment (ROI). Furthermore, local exchange carriers, for example, telephone service providers typically want to exploit as much of the existing operations, administration, management, and provisioning (OAM&P) solutions that they have in place today for VON lines, so as to allow the local exchange carriers to increase efficiency of the existing telecommunications network. Use of existing OAM&P may decrease the amount of necessary training and capital expenses.

### SUMMARY OF THE INVENTION

Some embodiments of the present invention provide methods for handling multiple calls using voice over network (VON) services. Instructions are received at a trunk gateway to apply a selected call waiting feature responsive to a new call request on a voice over network (VON) line involved in an active call. The selected call waiting feature is applied at the trunk gateway to the voice over network (VON) line involved in the active call responsive to the received instructions.

In further embodiments of the present invention, the instructions may include a shadow line number of a subscriber associated with the voice over network (VON) line and a telephone number of a calling party associated with the new call request. The selected call waiting feature may include caller identification on call waiting or call waiting deluxe.

In still further embodiments of the present invention, a signal indicating a disposition of the new call request may be received at the trunk gateway. In certain embodiments of the present invention, the received signal may be a dual tone multiple frequency (DTMF) signal indicating the disposition of the new call request.

In some embodiments of the present invention where the selected call waiting feature is caller identification, the disposition of the new call request comprises answering the new call request, applying general call waiting functionality or providing an identification of the calling party to the subscriber. In further embodiments of the present invention where the selected call waiting feature is call waiting deluxe, the disposition of the new call request may be applying general call waiting functionality, answering the new call request, conferencing in the new call request, placing new call request on hold with music, placing the new call request on hold without music, forwarding the new call request, dropping the active call and answering the new call request, forwarding the new call request to a messaging system or providing a busy signal or message to the calling party.

While described above primarily with reference to method aspects, it will be understood that the present invention further includes system and computer program product aspects.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of a data processing system suitable for use in some embodiments of the present invention.

FIG. 2 is a block diagram of a network suitable for use in some embodiments of the present invention.

FIGS. 3-5 are flowcharts illustrating operations according to some embodiments of the present invention.

FIGS. 6-10 are flowcharts illustrating operations for subscriber call dispositions according to some embodiments of the present invention

### DETAILED DESCRIPTION OF EMBODIMENTS OF THE PRESENT INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated selectivity features, integers, steps, operations, elements, and/or components, but do not preclude the presence or addition of one or more other selectivity features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described below with reference to block diagrams and/or flowchart illustrations of methods, systems and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

As discussed in the background of the present invention, currently to provide Internet telephony services to a customer, equipment, such as Integrated Access Devices (IADs), Analog Terminal Adaptors (ATAs), telephone adapters (TAs) and the like may be installed at the customer's premises. The installation and purchase of such equipment may not be desirable for any of the parties involved. BellSouth is actively pursuing a Voice Over Network (VON) implementation that does not require customer premises equipment (CPE), such as home gateways, analog telephone adaptors (ATAs) and the like. In particular, BellSouth's Central Office—Voice Over Network (CO_VON) may deliver voice communication signals via a communications network. According to some embodiments of CO_VON, customer premises equipment (CPE) may be eliminated, thereby eliminating the need to install equipment at the customer's premises. Furthermore, eliminating CPE may also reduce the total cost of VON service to the end user (customer). Furthermore, CO_VON may use the local loop CO Switch as an access point into the IP network, instead of, for example, a digital subscriber line (DSL), to connect customer premises hardware and equipment to VON services, thereby, reducing the number of outages that may be experienced interrupting the VON server. Details with respect to the CO_VON service provided by BellSouth and embodiments thereof are discussed in U.S. Provisional Application No. 60/569,504 filed May 7, 2004 and U.S. Provisional Application No. 60/615,922, filed Oct. 5, 2004, the contents of which are hereby incorporated herein by reference as if set forth in its entirety.

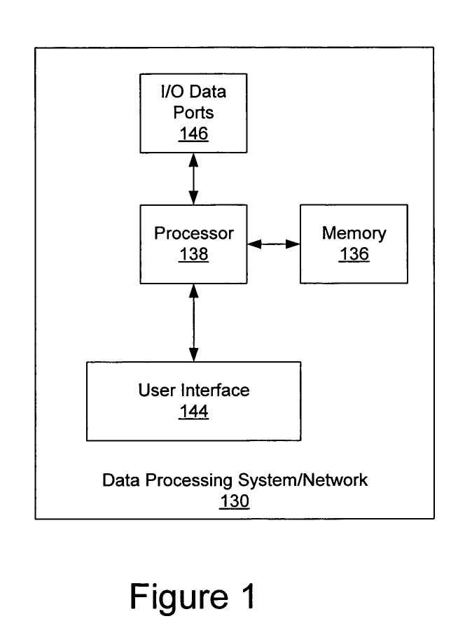

As will be discussed further below with respect to FIGS. 1 through 10, some embodiments of the present invention provide methods, systems and computer program products for handling multiple incoming CO_VON calls. In particular, according to some embodiments of the present invention, call waiting features, such as caller identification on call waiting and call waiting deluxe are provided using a trunk gateway. The trunk gateway may receive instructions from, for example, an application server indicating that the trunk gateway should apply the selected call waiting feature responsive to a new call request on a voice over network line involved in an active call. The trunk gateway may apply the selected call waiting feature to the voice over network line involved in the active call responsive to the received instructions. Furthermore, the trunk gateway can “listen” for signals from the CPE indicating the customer's disposition of the second call (new call request), for example, answer the call, forward the call to a message service and the like, as will be discussed further herein.

Referring now to FIG. 1, an exemplary embodiment of devices, for example, a target gateway (TGW), an application server (AS) or the like or data processing system 130 configured in accordance with some embodiments of the present invention will be discussed. The data processing system 130, which may be incorporated in, for example, a personal computer, a PDA, a wireless terminal/phone, or the like, may include a user interface 144, including, for example, input device(s) such as a keyboard or keypad, a display, a speaker and/or microphone, and a memory 136 that communicate with a processor 138. The data processing system 130 may further include an I/O data port(s) 146 that also communicates with the processor 138. The I/O data ports 146 can be used to transfer information between the data processing system 130 and another computer system or a network using, for example, an Internet Protocol (IP) connection. These components may be conventional components such as those used in many conventional data processing systems, which may be configured to operate as described herein.

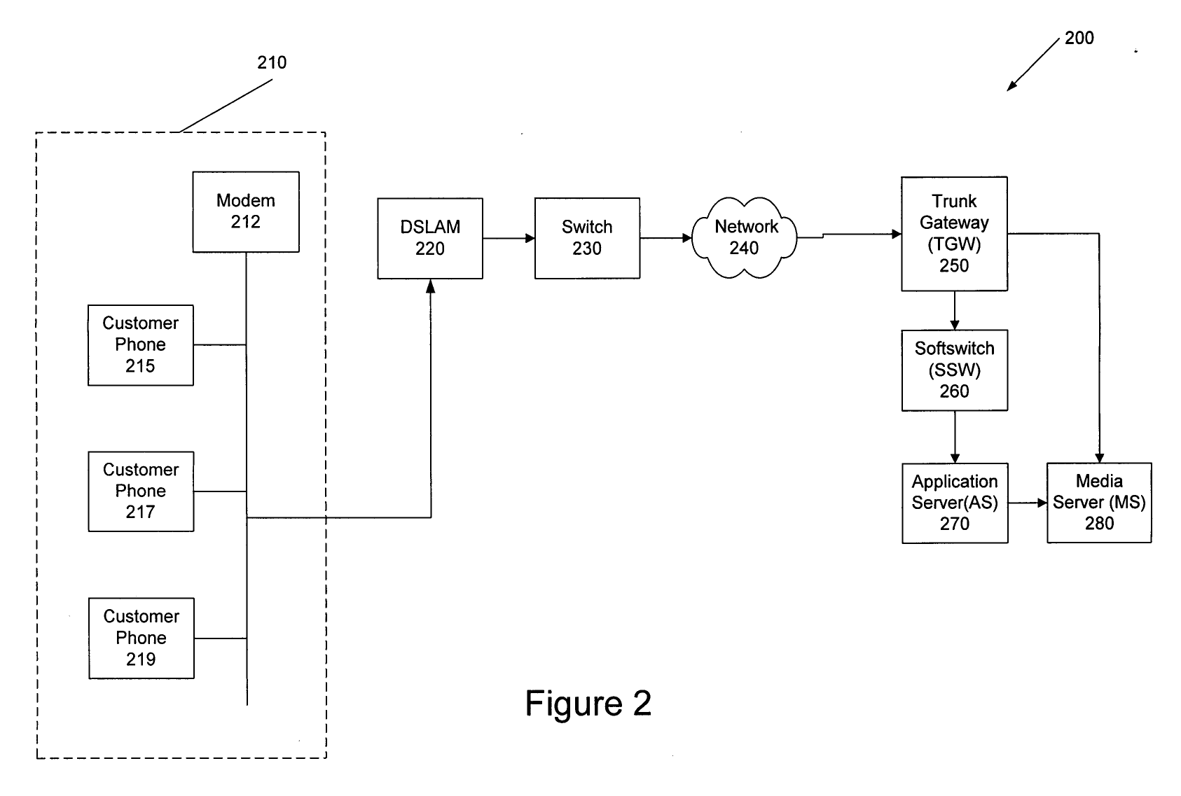

Referring now to FIG. 2, a block diagram of an exemplary network suitable for use in some embodiments of the present invention will be discussed. It will be understood that each of the blocks of the network 200 may include one or more of the elements discussed above with respect to FIG. 1, for example, I/O Data ports 146, a processor 138, a memory 136 and a user interface 144. The network 200 may be referred to as the Next Generation Network (NGN). As illustrated in FIG. 2, the network 200 may include one or more custumer phones 215, 217, 219, a modem 212, a Digital Subscriber Line Access Multiplexer (DSLAM) 220, a switch 230, a network 240, a trunk gateway (TGW) 250, a softswitch (SSW) 260, an application server (AS) 270 and a media server (MS) 280. It will be understood that the elements provided in FIG. 2 are provided for exemplary purposes only and embodiments of the present invention are not limited to the configuration provided therein. For example, there may be less than three or more than three customer phones provided without departing from the scope of the present invention.

As further illustrated in FIG. 2, the first, second and third customer phones 215, 217 and 219, for example, analog phones, are provided at the customer's premises (CPE) 210, for example, a private home or a corporate building, however, embodiments of the present invention are not limited to this configuration. The DSLAM is a mechanism provided, for example, at a phone company's central location that is configured to link multiple customer digital subscriber line (DSL) connections to a single high speed Asynchronous Transfer Mode (ATM) line. In some embodiments of the present invention, the network 240 may be the public switched telephone network (PSTN).

Details with respect to the functionality of the devices of FIG. 2 are discussed in U.S. Provisional Application No. 60/569,504 filed May 7, 2004 and U.S. Provisional Application No. 60/615,922, filed Oct. 5, 2004, the contents of which have been incorporated herein by reference. Thus, details with respect to the functionality of each of these devices will not be discussed further herein unless the functionality directly relates to one or more embodiments of the present invention.

In particular, some embodiments of the present invention provide call waiting features to CO-VON endpoints by the trunk gateway (TGW) instead of the Central Office Switch. The call waiting features may be provided using the TGW instead of the Central Office Switch because the CO-VON endpoint is switched to the TGW. The CO switch typically does not process new calls to the CO-VON subscriber when the CO-VON subscriber is currently established on a two-way call. The TGW receives and processes new calls to the CO-VON subscriber. As used herein, “call waiting features” refers to either caller identification on call waiting or call waiting deluxe, both of which will be explained in detail below. The call waiting features may be provided by the Softswitch Complex, which may include, for example, the Application Server (AS) 270, the Trunk Gateway (TGW) 250, the Media Server (MS) 280 and the Soft Switch(SSW) 260.

Exemplary operations of the network 200 according to some embodiments of the present invention will now be discussed with respect to FIG. 2. A subscriber may be on an active call using, for example, customer phone 215. Thus, a voice over network (VON) line is already established between the subscriber (user of customer phone 215) and a first caller. A second call request may be received on the VON line while the first call is still active. Thus, according to some embodiments of the present invention, the Applications Server (AS) 270 may be configured to send instructions to the trunk gateway (TGW) 250 indicating which call waiting feature, for example, caller identification on call waiting or call waiting deluxe, should be applied. It will be understood that the subscriber may select the type of call waiting feature and/or a default feature may be provided. The Application Server (AS) 270 has knowledge of which feature has been enabled for this particular subscriber. The instructions may include, for example, a shadow line number of the subscriber and the calling parties number. At this point, the Application Server (AS) 270 may set a call waiting timer.

The trunk gateway (TGW) 250 is configured to listen on the VON line for an indication of the customer's disposition of the second call. The options the customer has with respect to the disposition of the second call depend on which call waiting feature has been enabled. For example, if the customer has enabled call waiting deluxe (or call waiting deluxe is the default) the customer's disposition of the call may be, for example, answer the second call, put the second caller on hold, forward second call to a message service, forward the second call to another number, play a busy signal or message for the second caller, drop the first call and answer the second call, conference in the second call with the first call and the like. It will be understood the call waiting deluxe dispositions are provided herein for exemplary purposes only and, thus, embodiments of the present invention should not be limited to these examples. In some embodiments of the present invention, the trunk gateway (TGW) 250 may be configured to listen for dual tone multiple frequency (DTMF) signals, which indicate the customer's disposition of the second call.

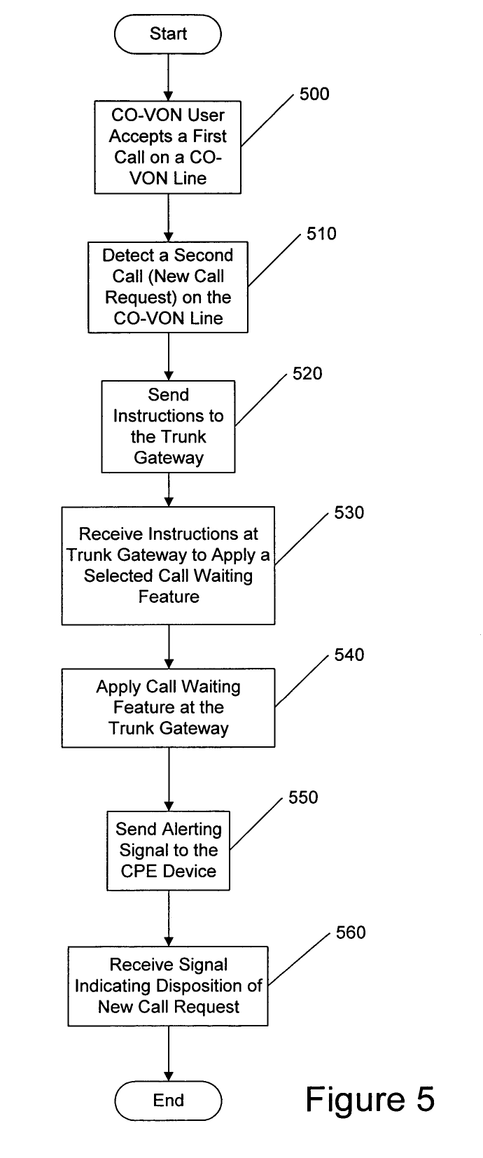

The trunk gateway (TGW) 250 may be further configured to apply generic call waiting functionality until the customer's disposition is received. At the same time the generic call waiting functionality is applied, the TGW 250 may be configured to transmit a customer premises (CPE) alerting signal (CAS) to the customer phone 215 in the present example. The TGW 250 may also be configured to start a call waiting re-alert timer at the same time. The TGW 250 may wait for an acknowledgement of the CAS from the customer phone 215. If an acknowledgment of the CAS is received, the TGW 250 may be configured to forward the calling party number and other calling party information to the customer phone 215. Once the calling parties information is sent, the details with respect to the next steps of operation depend on the particular call waiting feature and the customer's disposition thereof. These details will be discussed further below with respect to the flowcharts of FIGS. 5 through 10 below. If, on the other hand, no acknowledgement of the CAS is received, regular call waiting functionality will continue and no call waiting features according to embodiments of the present invention will be applied. It will be understood that other methods may be used to transmit the call party information without departing from the scope of the present invention. For example, text-to-speech or datrat transmission using a different protocol may be used may be used.

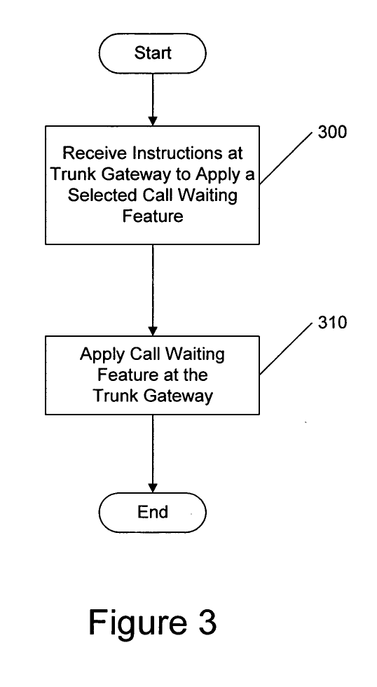

Operations according to some embodiments of the present invention will now be discussed with respect to the flowcharts of FIGS. 3 through 10. Referring now to FIG. 3, operations for handling multiple calls using voice over network (VON) services begin at block 300 by receiving instructions at a trunk gateway to apply a selected call waiting feature responsive to a new call request on a voice over network line involved in an active call. As discussed above, the selected call waiting feature may be caller identification on call waiting or call waiting deluxe, both of which will be discussed in further detail below. The instructions may include a shadow line number of a subscriber associated with the voice over network line and a telephone number of a calling party associated with the new call request and optionally the VON number. The trunk gateway applies the selected call waiting feature to the voice over network (VON) line involved in the active call responsive to the received instructions (block 310).

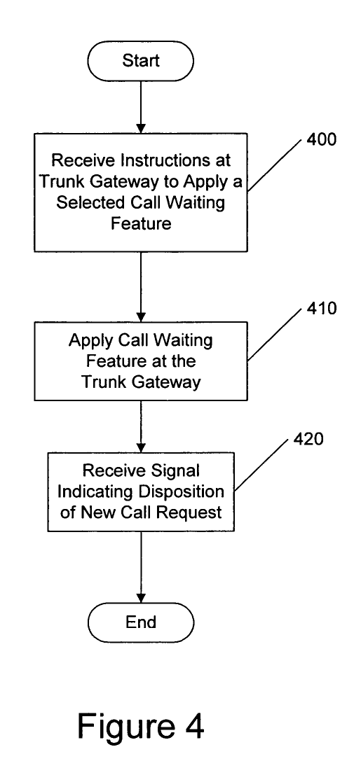

Referring now to FIG. 4, operations for handling multiple calls using voice over network (VON) services begin at block 400 by receiving instructions at a trunk gateway to apply a selected call waiting feature responsive to a new call request on a voice over network line involved in an active call. As discussed above, the selected call waiting feature may be caller identification on call waiting or call waiting deluxe, both of which will be discussed in further detail below. The instructions may include a shadow line number of a subscriber associated with the voice over network line and a telephone number of a calling party associated with the new call request and optionally the VON number. The trunk gateway applies the selected call waiting feature to the VON line involved in the active call responsive to the received instructions (block 410).

A signal indicating a disposition of the new call request is received at the trunk gateway (block 420). In some embodiments of the present invention the received signal is a dual tone multiple frequency (DTMF) signal indicating the disposition of the new call request. As discussed above, in some embodiments of the present invention, the selected call waiting feature may be caller identification. In these embodiments of the present invention, the disposition of the new call request may be, for example, answering the new call request, applying general call waiting functionality or providing an identification of the calling party to the subscriber. The details with respect to the dispositions for caller identification will be discussed in further detail below with respect to FIGS. 5 through 10.

In further embodiments of the present invention, the selected call waiting feature may be call waiting deluxe. In these embodiments of the present invention, the disposition of the new call request may be, for example, applying general call waiting functionality, answering the new call request, conferencing in the new call request, placing new call request on hold with music, placing the new call request on hold without music, forwarding the new call request, dropping the active call and answering the new call request, forwarding the new call request to a messaging system or providing a busy signal to the calling party. The details with respect to the disposition for call waiting deluxe will be discussed in further detail below with respect to FIGS. 5 through 10.

Referring now to FIG. 5, operations begin at block 500 by the CO_VON user/subscriber accepting a first call on a CO_VON line. Thus, a voice over network (VON) line is already established between the subscriber and a first caller. A second call may be detected on the VON line while the first call is still active (block 510). The Applications Server (AS) may be configured to send instructions to the trunk gateway (TGW) indicating which call waiting feature, for example, caller identification on call waiting or call waiting deluxe, should be applied (block 520). It will be understood that the subscriber may select the type of call waiting feature and/or a default feature may be provided. The Application Server (AS) has knowledge of which feature has been enabled for this particular subscriber. The instructions may include, for example, a shadow line number of the subscriber and the calling parties number. At this point, the Application Server (AS) may set a call waiting timer. The TGW may receive the instructions from the application server (block 530) and apply the selected call waiting feature (block 540).

The trunk gateway (TGW) is configured to listen on the VON line for an indication of the customer's disposition of the second call. The options the customer has with respect to the disposition of the second call depend on which call waiting feature has been enabled. For example, if the customer has enabled call waiting deluxe (or call waiting deluxe is the default) the customer's disposition of the call may be, for example, answer the second call, put the second caller on hold, forward second call to a message service, forward the second call to another phone number, play a busy signal or message for the second caller, drop the first call and answer the second call, conference in the second call with the first call and the like. It will be understood the call waiting deluxe dispositions are provided herein for exemplary purposes only and, thus, embodiments of the present invention should not be limited to these examples. In some embodiments of the present invention, the TGW may be configured to listen for dual tone multiple frequency (DTMF) signals, which indicate the customer's disposition of the second call.

The TGW may be further configured to apply generic call waiting functionality until the customer's disposition is received (block 530). At the same time the generic call waiting functionality is applied, the TGW may be configured to transmit a customer premises (CPE) alerting signal (CAS) to the CPE equipment, for example, an analog phone (block 550). The TGW may also be configured to start a call waiting re-alert timer at the same time. The call waiting re-alert timer may be configured to indicate that there is still a second call request. The TGW may wait for an acknowledgement of the CAS from the CPE. If an acknowledgment is received, the TGW may be configured to forward the calling party number and other calling party information to the subscriber. The TGW may receive a signal indicating the disposition of the new call request (block 560). If, on the other hand, no acknowledgement is received, regular call waiting functionality will continue. Call waiting features according to some embodiments of the present invention may or may not be applied.

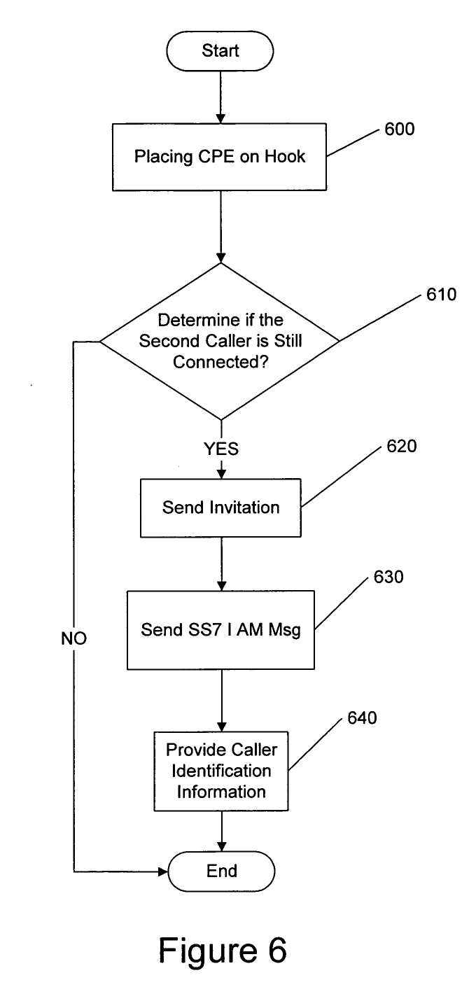

If the disposition indicates that the subscriber has enabled caller identification, the disposition of the new call request may be, for example, answering the new call request, applying general call waiting functionality or providing an identification of the calling party to the subscriber. If the subscriber chooses to answer the call, the subscriber may dial a code indicating that the call should be answered, for example, the subscriber may dial “##”. General call waiting functionality, i.e., no call waiting features according to embodiments of the present invention, may be applied if the re-alert timer set by the trunk gateway expires. If the subscriber's disposition is to provide an identification of the calling party, operations will be described further with respect to the flowchart of FIG. 6.

Referring now to FIG. 6, the CPE, for example, an analog phone, may go on hook (block 600). It is determined if the second caller is still trying to connect (requesting a call) (block 610). If it is determined that the second caller is no longer requesting a call (block 610), operations return to block 510 until another call is detected. If, on the other hand, it is determined that the second caller is still connected (block 610), the application server may be configured to send a SIP invitation including the shadow line number of the subscriber and the calling parties number to the trunk gateway (block 620). The trunk gateway may be configured to send an SS7 I AM message responsive to the invitation to the CO_VON host switch (block 630). The CO_VON host switch may be configured to provide the calling parties information to the subscriber, for example, the calling parties phone number may be provided to the subscriber (block 640) so as to allow the subscriber to determine whether to answer the phone.

Referring again to FIG. 5, the disposition (block 560) may also be determined by the calling party if, for example, the calling party hangs up. If the calling party hangs up, operations may return to block 510 until another new call request arrives on the VON line. Furthermore, if the call waiting timer set at the application server expires, operations may return to block 500 and repeat when another new call request arrives on the VON line.

If the application server (block 530) indicates that call waiting deluxe has been enabled by the subscriber, the disposition (block 560) of the new call request may be, for example, applying general call waiting functionality, answering the new call request, conferencing in the new call request, placing new call request on hold with music, placing the new call request on hold without music, forwarding the new call request to another number, dropping the active call and answering the new call request, forwarding the new call request to a messaging system or providing a busy signal to the calling party. Furthermore, the disposition of the new call could be any of those discussed above with respect to caller identification, for example, answering the new call request, applying general call waiting functionality, providing an identification of the calling party to the subscriber, calling party hangs up and call waiting timer expires at the application server.

In particular, if the subscriber's disposition is to send the second call to a messaging service (block 560), the subscriber may dial a code, for example, “#8”. The target gateway may receive the dialed code and transmit a message to the application server to send the second call to the messaging service. The operations return to block 510 until another call request is detected. If the subscriber's disposition is to drop the first call and answer the second call (block 560), the subscriber dials a code, for example, “#7”. The target gateway receives the dialed code and the call waiting timers may be cleared. The target gateway accepts the second call request and sends a goodbye message to the first caller through the application server.

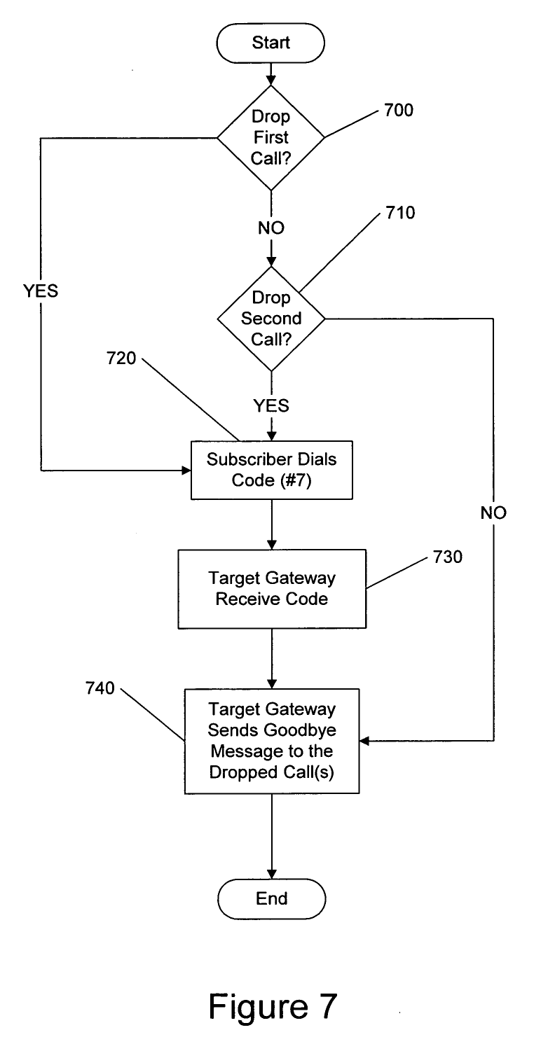

If the subscriber's disposition is to conference the second call in (block 560), the subscriber may dial a code, for example, “#5”, and again, the call waiting timers will be cleared. Details with respect to conferencing the second call will be discussed with respect to FIG. 7. In particular, once the subscriber dials the code (#5), the second call is connected. Once connected, the user has disposition options that are specific to the first call or second call. If the subscriber dials a code, it is determined if the subscriber wants to drop the first call (block 700). If it is determined that the subscriber does not want to drop the first call (block 700), it is determined if the subscriber wants to drop the second call (block 710). If it is determined that the subscriber does not want to drop the second call (block 710), operations proceed to block 740 where the target gateway is configured to send goodbye messages to both the first and second calls once the call is completed. If, on the other hand, it is determined that the subscriber wants to drop the first (block 700) or the second (block 710) call, the subscriber dials a code, for example, “#7” (block 720). The target gateway receives the dialed code (block 730) and the call waiting timers will be cleared. The target gateway transmits a goodbye message to the first or second caller (block 740).

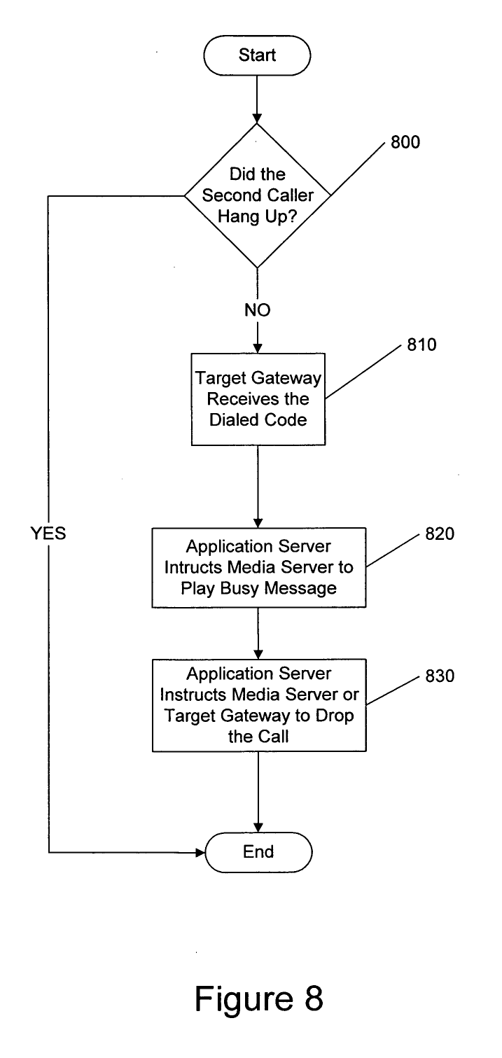

Referring again to FIG. 5, if the subscriber's disposition of the call is to play a busy message to the second caller (block 560), the subscriber dials a code, for example, “#M”. Operations for providing a busy signal according to some embodiments of the present invention will be discussed further with respect to the flowchart of FIG. 8. Referring now to FIG. 8, it is determined if the second caller has hung up (block 800). If it is determined that the second caller has hung up (block 800), operations return to block 510 until a new call request is detected. If, on the other hand, it is determined that the second caller is still on the line (block 800), the target gateway receives the dialed code, for example, “#M” (block 810), and sends a message to the application server instructing the application server to play a busy message (block 820). The call waiting timers may cleared. The application server may instruct the media server or the target gateway to drop the incoming call (block 830) and operations return to block 510 until another call request is received.

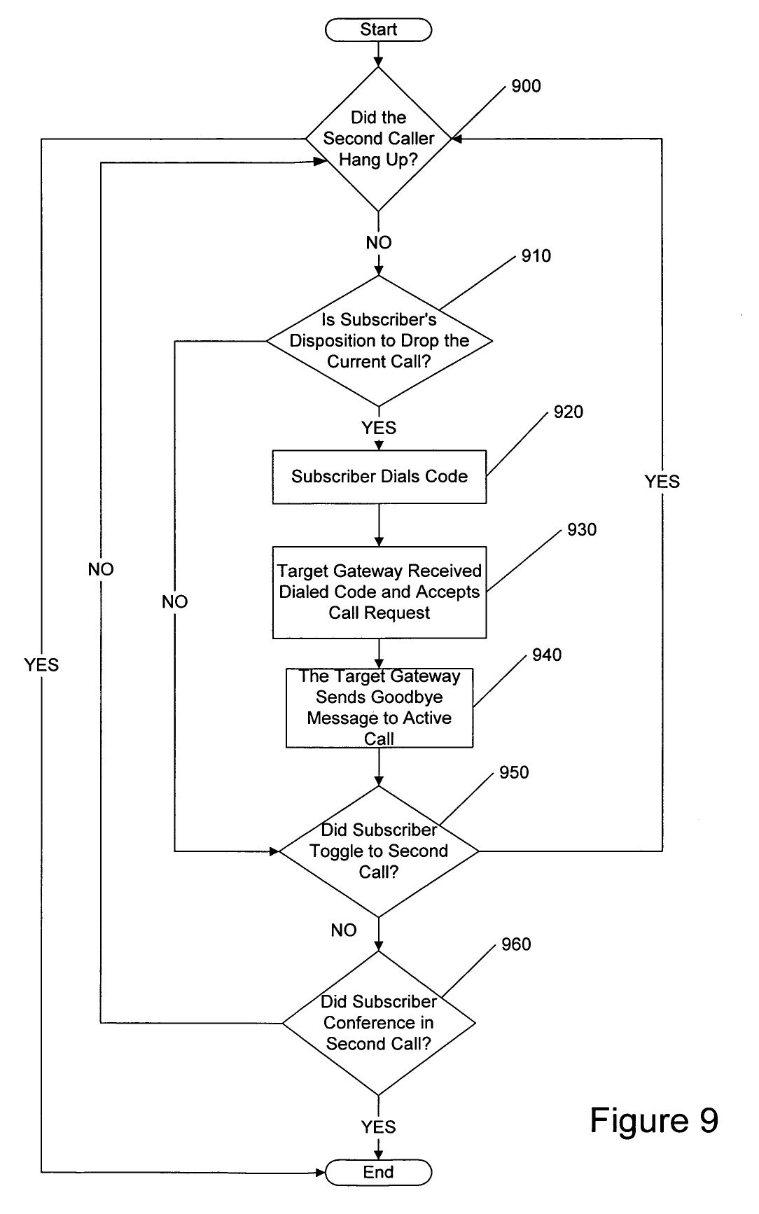

Referring again to FIG. 5, if the subscriber's disposition of the call is to place the second call on hold (block 560), the subscriber dials a code, for example, “#4”. The target gateway receives the dialed code and sends a message to the application server indicating that the second caller should be placed on hold. The call waiting timers may be cleared. The application server instructs the media server to play hold message and place the second call on hold. Once the call is placed on hold, the subscriber may further indicate the disposition of the call. For example, the subscriber may toggle to the call that was placed on hold and place the first (active) call on hold, drop the first (active) call and return to the held call, the user may join the first and second callers in a conference call or the caller may hang up. Details with respect to dispositions after the call is placed on hold according to some embodiments of the present invention will now be discussed with respect to the flowchart of FIG. 9.

Referring now to FIG. 9, it is determined if the second call is still on the line (block 900). If it is determined that the second caller is no longer on the line (block 900), operations return to block 510 until another call request is received. If, on the other hand, it is determined that the second caller is still on the line (block 900), it is determined if the subscriber's disposition is to drop the current call and return to the held call (block 910). If is determined that the subscriber wants to drop the first call (block 910), the subscriber dials a code, for example, “#7” (block 920). The target gateway receives the dialed code and accepts the second call request (block 930). The target gateway transmits a goodbye message to the first (active caller) (block 940). If it is determined that the subscriber does not want to drop the first call (block 910), it is determined if the subscriber wants to toggle back and forth between the first and second calls (block 950). If the subscriber wants to toggle (block 950), the subscriber dials a code, for example, “##” and operations return to block 900 and repeat. If the subscriber does not want to toggle (block 950), operations proceed to block 960 and it is determined if the subscriber wants to conference in the second call (block 960). If the subscriber wants to conference in the second call, the user dials a code, for example, “#5” and operations proceed along the lines discussed above with respect to FIG. 7. If, on the other hand, it is determined that the subscriber does not want to conference in the second call, operations return to block 900 and repeat.

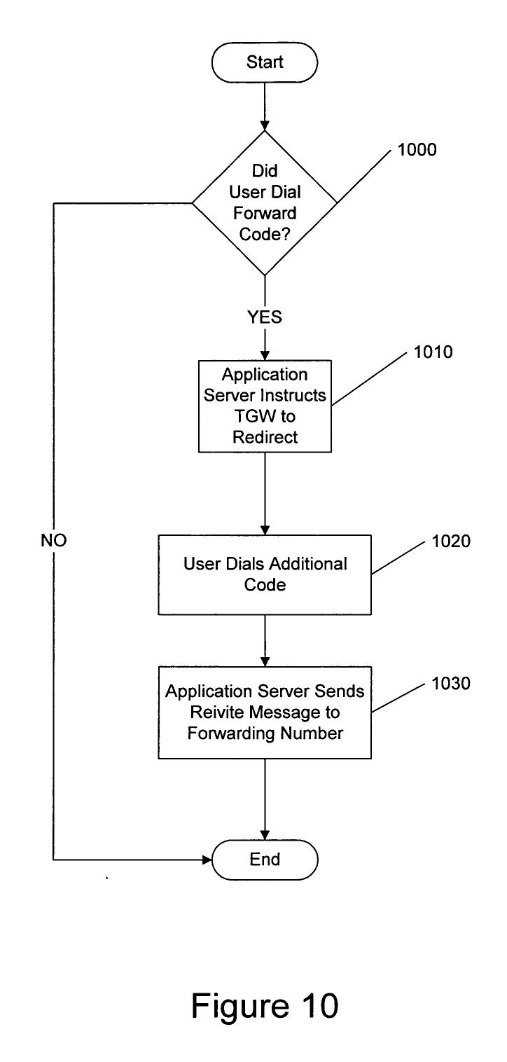

Referring again to FIG. 5, if the subscriber's disposition is to answer the call (block 560), the subscriber may dial a code, for example, “##” and the call waiting timers will be cleared. Once the second call is answered, operations may proceed along the lines discussed above with respect to FIG. 9. Finally, if the subscriber's disposition is to forward the call, the user dials a code, for example, “#3”. The target gateway receives the dialed code and instructs the application server to forward the call and the call waiting timers may be cleared. Further operations for forwarding the second call according to some embodiments of the present invention will be discussed with respect to the flowchart of FIG. 10.

Referring now to FIG. 10, it is determined if the subscriber has dialed the forward code, for example, “#3” (block 1000). If it is determined that the subscriber has dialed the forward code (block 1000), the application server instructs the target gateway to redirect the second call to the media server to assign a forwarding number (block 1010). The subscriber dials the forwarding ten digit number (block 1020). The application server sends a reinvite message to the second caller using the forwarding number (block 1030). If, on the other hand, it is determined that the subscriber has not dialed the forward code (block 1000), operations return to block 560 until a user's disposition is received or the caller hangs up.

As discussed briefly above with respect to FIGS. 1 through 10, some embodiments of the present invention provide methods, systems and computer program products for handling multiple incoming CO_VON calls simultaneously. According to some embodiments of the present invention, caller identification and call waiting deluxe features may be available to subscribing CO_VON users. The addition of these features may make CO_VON services more attractive to customers as it may make it closer to typical POTS services.

In the drawings and specification, there have been disclosed embodiments of the invention and, although specific terms are employed, they are used in a generic and descriptive sense only and not for purposes of limitation, the scope of the invention being set forth in the following claims.

1. A method for handling multiple calls using voice over network (VON) services, comprising:
receiving instructions at a trunk gateway to apply a selected call waiting feature responsive to a new call request on a VON line involved in an active call; and
applying, at the trunk gateway, the selected call waiting feature to the VON line involved in the active call responsive to the received instructions.

2. The method of claim 1, wherein receiving instructions comprises receiving a shadow line number of a subscriber associated with the VON line and a telephone number of a calling party associated with the new call request from an application server.

3. The method of claim 1, wherein the selected call waiting feature comprises caller identification on call waiting or call waiting deluxe.

4. The method of claim 3, further comprising receiving, at the trunk gateway, a signal indicating a disposition of the new call request.

5. The method of claim 4, wherein receiving a signal comprises receiving a dual tone multiple frequency (DTMF) signal indicating the disposition of the new call request.

6. The method of claim 4, wherein the selected call waiting feature comprises caller identification and wherein the disposition of the new call request comprises answering the new call request, applying general call waiting functionality or providing an identification of the calling party to the subscriber.

7. The method of claim 4, wherein the selected call waiting feature comprises call waiting deluxe and wherein the disposition of the new call request comprises applying general call waiting functionality, answering the new call request, conferencing in the new call request, placing new call request on hold with music, placing the new call request on hold without music, forwarding the new call request, dropping the active call and answering the new call request, forwarding the new call request to a messaging system or providing a busy signal to the calling party.

8. A system for handling multiple calls using voice over network (VON) services, comprising:
a trunk gateway configured to:
receive instructions to apply a selected call waiting feature responsive to a new call request on a VON line involved in an active call; and
apply the selected call waiting feature to the VON line involved in the active call responsive to the received instructions.

9. The system of claim 8, wherein the received instructions comprise a shadow line number of a subscriber associated with the VON line and a telephone number of a calling party associated with the new call request.

10. The system of claim 8, wherein the selected call waiting feature comprises caller identification on call waiting or call waiting deluxe.

11. The system of claim 10, wherein the trunk gateway is further configured to receive a signal indicating a disposition of the new call request.

12. The system of claim 11, wherein the selected call waiting feature comprises caller identification and wherein the disposition of the new call request comprises answering the new call request, applying general call waiting functionality or providing an identification of the calling party to the subscriber.

13. The system of claim 11, wherein the selected call waiting feature comprises call waiting deluxe and wherein the disposition of the new call request comprises applying general call waiting functionality, answering the new call request, conferencing in the new call request, placing new call request on hold with music, placing the new call request on hold without music, forwarding the new call request, dropping the active call and answering the new call request, forwarding the new call request to a messaging system or providing a busy signal to the calling party.

14. A computer program product for handling multiple calls using voice over network (VON) services, the computer program product comprising:
a computer readable medium having computer readable program code embodied therein, the computer readable program product comprising:
computer readable program code configured to receive instructions at a trunk gateway, from an application server, to apply a selected call waiting feature responsive to a new call request on a VON line involved in an active call; and
computer readable program code configured to apply, at the trunk gateway, the selected call waiting feature to the VON line involved in the active call responsive to the received instructions.

15. The computer program product of claim 14, wherein the instructions comprise a shadow line number of a subscriber associated with the VON line and a telephone number of a calling party associated with the new call request.

16. The computer program product of claim 15, wherein the selected call waiting feature comprises caller identification on call waiting or call waiting deluxe.

17. The computer program product of claim 16, further comprising computer readable program code configured to receive, at the trunk gateway, a signal indicating a disposition of the new call request.

18. The computer program product of claim 17, wherein the computer readable program code configured to receive a signal comprises computer readable program code configured to receive a dual tone multiple frequency (DTMF) signal indicating the disposition of the new call request.

19. The computer program product of claim 17, wherein the selected call waiting feature comprises caller identification and wherein the disposition of the new call request comprises answering the new call request, applying general call waiting functionality or providing an identification of the calling party to the subscriber.

20. The computer program product of claim 17, wherein the selected call waiting feature comprises call waiting deluxe and wherein the disposition of the new call request comprises applying general call waiting functionality, answering the new call request, conferencing in the new call request, placing new call request on hold with music, placing the new call request on hold without music, forwarding the new call request, dropping the active call and answering the new call request, forwarding the new call request to a messaging system or providing a busy signal to the calling party.
